(19) United States
(12) Patent Application Publication
(10) Pub. No.: US 2026/0204536 A1
(43) Pub. Date: Jul. 16, 2026

(54) ELECTRODE LAMINATE MODULE

(71) Applicant: TOYOTA JIDOSHA KABUSHIKI KAISHA, Toyota-shi (JP)

(72) Inventor: Yushi SUZUKI, Mishima-shi (JP)

(73) Assignee: TOYOTA JIDOSHA KABUSHIKI KAISHA, Toyota-shi (JP)

(21) Appl. No.: 19/403,474

(22) Filed: Nov. 28, 2025

(30) Foreign Application Priority Data
Jan. 10, 2025 (JP) 2025-004106

(51) Int. Cl. H01M 4/00; H01M 4/02

(52) U.S. Cl. CPC H01M 4/00; H01M 2004/021; H01M 2004/027; H01M 2004/028; H01M 2200/00

(57) ABSTRACT

An electrode laminate module includes a plurality of electrode laminates, a cathode metal-vapor-deposited resin layer, and an anode metal-vapor-deposited resin layer. A cathode metal foil of each of the electrode laminates is in contact with a cathode vapor-deposited metal film of the cathode metal-vapor-deposited resin layer such that a plurality of the cathode metal foils is electrically connected in parallel to each other. An anode metal foil of each of the electrode laminates is in contact with an anode vapor-deposited metal film of the anode metal-vapor-deposited resin layer such that a plurality of the anode metal foils is electrically connected in parallel to each other. A cathode active material layer, a separator layer or a solid electrolyte layer, and an anode active material layer are sealed with the cathode metal foil, the anode metal foil, and a resin sealing member.

### CROSS-REFERENCE TO RELATED APPLICATION

This application claims priority to Japanese Patent Application No. 2025-004106 filed on January 10, 2025. The disclosure of the above-identified application, including the specification, drawings, and claims, is incorporated by reference herein in its entirety.

### BACKGROUND

### 1. Technical Field

The present disclosure relates to an electrode laminate module.

### 2. Description of Related Art

An electrode laminate module is obtained by housing, in an outer casing etc., an electrode laminate including at least a cathode metal foil, a cathode active material layer, a separator layer or a solid electrolyte layer, an anode active material layer, and an anode metal foil in the stated order.

In recent years, along with development of portable electronic devices such as mobile phones and practical application of battery electric vehicles, there has been an increasing demand for small-size, lightweight, high-capacity, and high-energy density electrode laminate modules. For example, as described in Japanese Unexamined Patent Application Publication No. 6-333551 (JP 6-333551 A) and WO 2024/070724, research has been conducted on electrode laminate modules including a plurality of electrode laminates connected in parallel.

For example, JP 6-333551 A discloses a battery characterized as follows. A battery element including a cathode active material, a separator, and an anode active material is disposed between upper and lower current collectors and the peripheral edge of the battery element is sealed with an adhesive to form a thin unit cell. A series of batteries is formed by connecting a plurality of the thin unit cells with the adhesive at current collector portions. At least part of the connecting portion of the series of batteries has a cut or recess. With the battery described in JP 6-333551 A, it is possible to easily obtain a battery capacity as needed and to facilitate parallel connection of batteries.

WO 2024/070724 discloses a flexible battery in which a plurality of power generation elements is encapsulated in an outer casing. The flexible battery is characterized as follows. Each of the power generation elements includes a cathode, an anode, and a solid electrolyte layer disposed between the cathode and the anode. The cathode includes a cathode mixture layer and a sheet-shaped conductive substrate disposed on the surface of the cathode mixture layer. The anode includes an anode mixture layer and a sheet-shaped conductive substrate disposed on the surface of the anode mixture layer. The power generation elements are arranged on a flexible substrate. The respective cathodes are directly connected to a current collector and therefore connected to each other by the current collector. The respective anodes are directly connected to a current collector and therefore connected to each other directly by the current collector. An external connection terminal is connected to each of the current collector connecting the cathodes and the current collector connecting the anodes. With the flexible battery described in WO 2024/070724, the internal resistance is reduced.

### SUMMARY

The above battery including the electrode laminates connected in parallel is used by bending the battery at the connecting portion between the electrode laminates, and metal foils are disposed at the connecting portion to connect the electrode laminates adjacent to each other. When the metal foils are used at the connecting portion in this way, the metal foils are likely to break due to metal fatigue caused by repeated bending.

Therefore, an object of the present disclosure is to suppress breakage of a connecting portion between a plurality of electrode laminates due to bending.

The present disclosure achieves the above object by the following means.

### First Aspect

An electrode laminate module including a plurality of electrode laminates, a cathode metal-vapor-deposited resin layer, and an anode metal-vapor-deposited resin layer, in which

each of the electrode laminates includes at least a cathode metal foil, a cathode active material layer, a separator layer or a solid electrolyte layer, an anode active material layer, and an anode metal foil in the stated order,

the cathode metal foil of each of the electrode laminates is in contact with a cathode vapor-deposited metal film of the cathode metal-vapor-deposited resin layer such that a plurality of the cathode metal foils is electrically connected in parallel to each other,

the anode metal foil of each of the electrode laminates is in contact with an anode vapor-deposited metal film of the anode metal-vapor-deposited resin layer such that a plurality of the anode metal foils is electrically connected in parallel to each other, and

the cathode active material layer, the separator layer or the solid electrolyte layer, and the anode active material layer of each of the electrode laminates are sealed with the cathode metal foil, the anode metal foil, and a resin sealing member between the cathode metal foil and the anode metal foil.

### Second Aspect

The electrode laminate module according to the first aspect, in which:

a dimension of the separator layer or the solid electrolyte layer and a dimension of the anode active material layer are larger than a dimension of the cathode active material layer when viewed in a laminating direction of the electrode laminate; and

the resin sealing member is in contact with a peripheral edge of the separator layer or the solid electrolyte layer and/or a peripheral edge of the anode active material layer, and is not in contact with a peripheral edge of the cathode active material layer.

### Third Aspect

The electrode laminate module according to the first or second aspect, in which a thickness of the cathode vapor-deposited metal film and/or the anode vapor-deposited metal film is 1.0 μm or less.

### Fourth Aspect

The electrode laminate module according to any one of the first to third aspects, in which a thickness of the cathode metal foil and/or the anode metal foil is 5 μm or more and 500 μm or less.

### Fifth Aspect

The electrode laminate module according to any one of the first to fourth aspects, in which:

a sealed portion that is sealed with the resin sealing member and an unsealed portion other than the sealed portion are provided when viewed in a laminating direction of the cathode metal-vapor-deposited resin layer and the anode metal-vapor-deposited resin layer; and

the cathode vapor-deposited metal film and the anode vapor-deposited metal film do not overlap each other at the unsealed portion when viewed in the laminating direction of the cathode metal-vapor-deposited resin layer and the anode metal-vapor-deposited resin layer.

According to the present disclosure, it is possible to suppress the breakage of the connecting portion between the electrode laminates due to the bending.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram of an electrode laminate module of the present disclosure;

FIG. 2 is a schematic diagram of the electrode laminate module of the present disclosure; and

FIG. 3 is a schematic diagram illustrating an example of the present disclosure.

### DETAILED DESCRIPTION OF EMBODIMENTS

Hereinafter, an embodiment of the present disclosure will be described in detail. The present disclosure is not limited to the following embodiment, and various modifications may be made without departing from the scope of the present disclosure. The same elements are denoted by the same signs throughout the drawings, and description thereof will not be repeated.

### Electrode Laminate Module

An electrode laminate module of the present disclosure includes a plurality of electrode laminates, a cathode metal-vapor-deposited resin layer, and an anode metal-vapor-deposited resin layer, in which

each of the electrode laminates includes at least a cathode metal foil, a cathode active material layer, a separator layer or a solid electrolyte layer, an anode active material layer, and an anode metal foil in the stated order,

the cathode metal foil of each of the electrode laminates is in contact with a cathode vapor-deposited metal film of the cathode metal-vapor-deposited resin layer such that a plurality of the cathode metal foils is electrically connected in parallel to each other,

the anode metal foil of each of the electrode laminates is in contact with an anode vapor-deposited metal film of the anode metal-vapor-deposited resin layer such that a plurality of the anode metal foils is electrically connected in parallel to each other, and

the cathode active material layer, the separator layer or the solid electrolyte layer, and the anode active material layer of each of the electrode laminates are sealed with the cathode metal foil, the anode metal foil, and a resin sealing member between the cathode metal foil and the anode metal foil.

With the above electrode laminate module, it is possible to suppress breakage of a connecting portion between the electrode laminates due to bending.

In related-art electrode laminate modules, metal foils are present at a connecting portion between a plurality of electrode laminates. In this case, the metal foils at the connecting portion may break due to metal fatigue caused by repeated bending. Therefore, the present inventors have conducted research on the possibility of suppressing breakage of the metal foils at the connecting portion by replacing the metal foils with metal-vapor-deposited resin layers. In this case, however, the metal-vapor-deposited resin layer has higher gas permeability than the metal foil. Therefore, there is a problem in that moisture that has permeated the metal-vapor-deposited resin layer is likely to come into contact with the electrode laminate.

With the electrode laminate module of the present disclosure, it is possible to reduce the likeliness of contact between moisture and the electrode laminate while suppressing the breakage of the metal foils at the connecting portion.

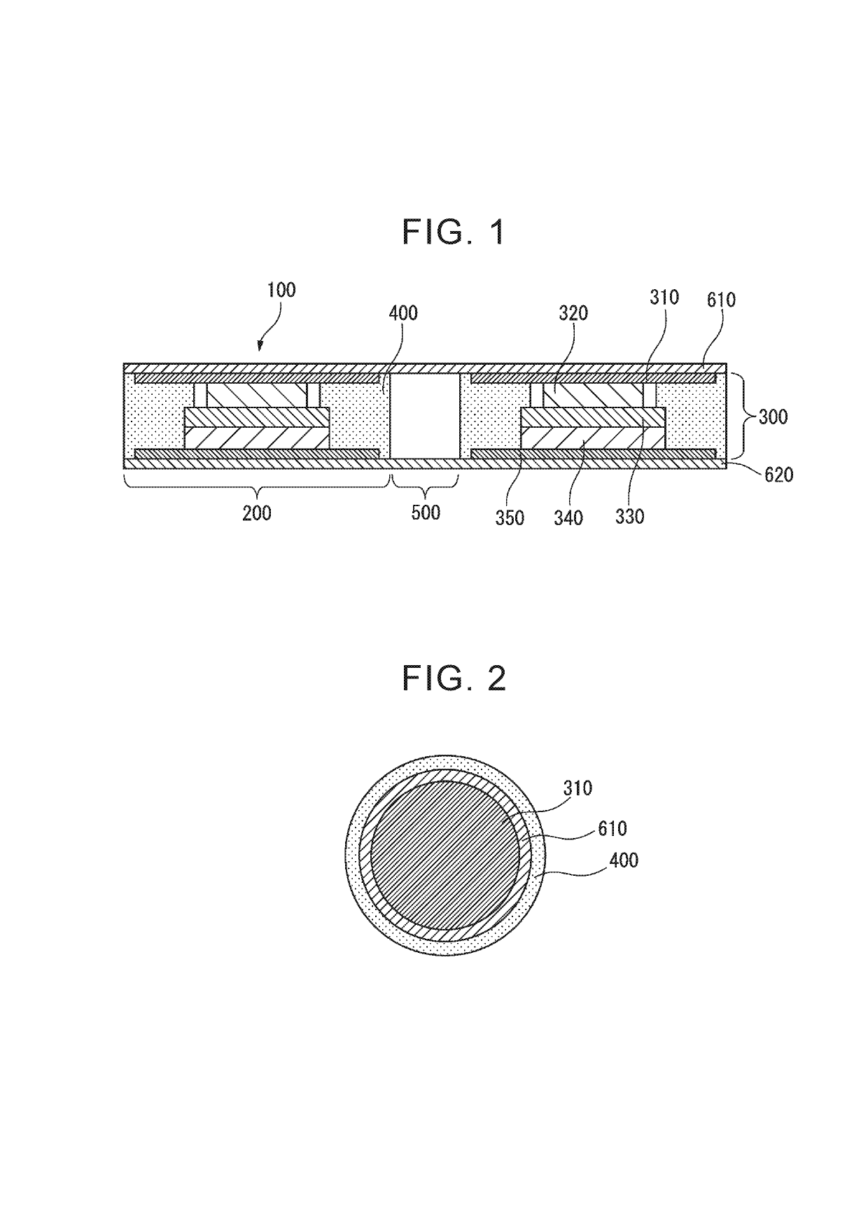

A sectional view of the electrode laminate module of the present disclosure is shown in FIG. 1, but the embodiment of the present disclosure is not limited thereto. In the electrode laminate module of the present disclosure shown in FIG. 1, a cathode metal-vapor-deposited resin layer 610 and/or an anode metal-vapor-deposited resin layer 620 are/is used at a connecting portion between a plurality of electrode laminates 300. Compared to the metal foil, the metal-vapor-deposited resin layer has bending resistance. Therefore, the breakage of the connecting portion due to metal fatigue can be suppressed. A cathode active material layer 320, a separator layer 330 or a solid electrolyte layer (not shown), and an anode active material layer 340 of each of the electrode laminates 300 are sealed with a cathode metal foil 310, an anode metal foil 350, and a resin sealing member 400. Therefore, contact between moisture and the electrode laminate 300 can be suppressed.

In the present disclosure, the electrode laminate module includes a sealed portion 200 in which the electrode laminate is sealed with the resin sealing member 400, and an unsealed portion 500 other than the sealed portion 200. The electrode laminate module of the present disclosure may be bent at the unsealed portion 500.

In the electrode laminate module of the present disclosure, when viewed in the laminating direction of the cathode metal-vapor-deposited resin layer and the anode metal-vapor-deposited resin layer, the cathode vapor-deposited metal film and the anode vapor-deposited metal film need not overlap each other at the unsealed portion. Therefore, contact between the cathode vapor-deposited metal film and the anode vapor-deposited metal film can be suppressed when the electrode laminate module is bent at the unsealed portion.

### Electrode Laminate

In the present disclosure, the electrode laminates are provided to the electrode laminate module. Each of the electrode laminates includes at least the cathode metal foil, the cathode active material layer, the separator layer or the solid electrolyte layer, the anode active material layer, and the anode metal foil in the stated order.

In the present disclosure, the electrode laminate may be a liquid-based electrode laminate or a solid electrode laminate. In the present disclosure, the "liquid-based electrode laminate" refers to a battery that uses an electrolyte solution as the electrolyte, and the "solid electrode laminate" refers to a battery that uses at least a solid electrolyte as the electrolyte. Therefore, the solid electrode laminate may use a solid electrolyte alone or a combination of a solid electrolyte and a liquid electrolyte (electrolyte solution) as the electrolyte.

In the present disclosure, the shape of the electrode laminate when viewed in the laminating direction of the electrode laminate is not particularly limited. Examples thereof include a triangular shape, a square shape, a hexagonal shape, and a circular shape shown in FIG. 2.

### Cathode Metal Foil

In the present disclosure, the cathode metal foil of each of the electrode laminates is in contact with the cathode vapor-deposited metal film of the cathode metal-vapor-deposited resin layer such that a plurality of the cathode metal foils is electrically connected in parallel to each other.

In the present disclosure, examples of the material of the cathode metal foil include, but are not limited to, aluminum, aluminum alloys, stainless steel, and nickel. As the material of the cathode metal foil, a metal having oxidation resistance is particularly preferred.

In the present disclosure, the thickness of the cathode metal foil is not particularly limited, but may be 1 μm or more, 5 μm or more, 10 μm or more, 20 μm or more, 30 μm or more, or 40 μm or more, and may be 500 μm or less, 300 μm or less, 100 μm or less, 80 μm or less, 70 μm or less, 60 μm or less, or 50 μm or less.

### Cathode Active Material Layer

In the present disclosure, the cathode active material layer is included in each of the electrode laminates. The cathode active material layer of the present disclosure contains at least cathode active material particles, and may optionally contain a solid electrolyte, a binder, and a conductive aid. For example, the cathode active material layer can be obtained by applying a cathode mixture containing at least the cathode active material particles to the separator layer or the solid electrolyte layer.

The content of the cathode active material in the cathode active material layer of the present disclosure is not particularly limited, but may be 1% by mass or more, 5% by mass or more, 10% by mass or more, or 15% by mass or more, and may be 50% by mass or less, 45% by mass or less, 40% by mass or less, or 35% by mass or less.

The cathode active material is not particularly limited. Examples of the cathode active material include, but are not limited to, lithium cobalt oxide (LiCoO₂), lithium manganese oxide (LiMn₂O₄), lithium nickel cobalt manganese oxide (NCM: LiCO_{1/3}Ni_{1/3}Mn_{1/3}O₂), and LiNiCoMn.

The cathode active material may have any shape such as a spherical shape or a fibrous shape.

The particle size D₅₀ of the cathode active material may be, for example, 1 nm or more, 5 nm or more, or 10 nm or more, and may be 500 μm or less, 100 μm or less, 50 μm or less, or 30 μm or less. The particle size D₅₀ is defined as the particle size (median diameter) corresponding to 50% of the volume-based cumulative particle size distribution as determined by a laser diffraction and scattering method.

The solid electrolyte optionally contained in the cathode active material layer of the present disclosure may be any known solid electrolyte for secondary batteries. Examples of the solid electrolyte include inorganic solid electrolytes such as sulfide solid electrolytes and oxide solid electrolytes, and organic polymeric electrolytes such as polymer electrolytes. The electrolyte is preferably a sulfide solid electrolyte or an oxide solid electrolyte particularly from the viewpoint of heat resistance. The solid electrolyte may be, for example, in the form of particles. The solid electrolyte may be one type used alone or two or more types used in combination.

Examples of the sulfide solid electrolyte include, but are not limited to, Li₂S-P₂S₅, LiI-LiBr-Li₂S-P₂S₅, and Li₂S-GeS₂. The sulfide solid electrolyte may be glass (amorphous) or glass ceramic.

Examples of the oxide solid electrolyte include, but are not limited to, Li₇La₃Zr₂O₁₂ and Li₇₋₃ₓLa₃Zr₂AlₓO₁₂. The oxide solid electrolyte may be amorphous or crystalline.

Examples of the polymer electrolyte include, but are not limited to, polyethylene oxide (PEO), polypropylene oxide (PPO), and copolymers thereof.

The content of the solid electrolyte optionally contained in the cathode active material layer of the present disclosure is not particularly limited, but may be 1% by mass or more, 5% by mass or more, 10% by mass or more, or 13% by mass or more, and may be 60% by mass or less, 50% by mass or less, 40% by mass or less, or 30% by mass or less.

In the present disclosure, the conductive aid optionally contained in the cathode active material layer may be any known conductive aid that is used in secondary batteries. Specific examples of the conductive aid include carbon materials such as vapor grown carbon fibers (VGCFs), carbon nanotubes (CNTs), carbon nanofibers (CNFs), and graphite. The conductive aid may be one type used alone or two or more types used in combination. The conductive aid may be in various forms such as powder or fibers.

The content of the conductive aid optionally contained in the cathode active material layer of the present disclosure is not particularly limited, but may be 0.1% by mass or more, 0.5% by mass or more, 1% by mass or more, or 3% by mass or more, and may be 20% by mass or less, 15% by mass or less, 10% by mass or less, or 8% by mass or less.

The binder optionally contained in the cathode active material layer of the present disclosure may be any known binder that is used in secondary batteries. Examples of the binder include styrene butadiene rubber (SBR), butadiene rubber (BR), polyvinylidene difluoride (PVDF), and polytetrafluoroethylene (PTFE). The binder may be one type used alone or two or more types used in combination.

The content of the binder optionally contained in the cathode active material layer of the present disclosure is not particularly limited, but may be 0.1% by mass or more, 0.5% by mass or more, 1% by mass or more, or 3% by mass or more, and may be 20% by mass or less, 15% by mass or less, 10% by mass or less, or 8% by mass or less.

### Separator Layer

In the present disclosure, the separator layer may be included in each of the electrode laminates.

In the present disclosure, the separator layer may be any separator layer commonly used in secondary batteries, and examples thereof include those made of resins such as butadiene rubber (BR), polyethylene (PE), polypropylene (PP), polyester, and polyamide. The separator layer may have a single-layer structure or a multi-layer structure. Examples of the separator layer having a multi-layer structure include a separator having a two-layer structure of PE/PP, and a separator having a three-layer structure of PP/PE/PP or PE/PP/PE. The separator layer may be made of a nonwoven fabric such as a cellulose nonwoven fabric, a resin nonwoven fabric, or a glass fiber nonwoven fabric. In the present disclosure, the separator layer may further contain a solid electrolyte.

In the present disclosure, the dimension of the separator layer may be equal to or larger than the dimension of the cathode active material layer when viewed in the laminating direction of the electrode laminate. In the present disclosure, the larger dimension means that, when two shapes are superimposed, one shape encompasses the entirety of the other shape.

### Solid Electrolyte Layer

In the present disclosure, the solid electrolyte layer may be included in each of the electrode laminates.

In the present disclosure, the dimension of the solid electrolyte layer may be equal to or larger than the dimension of the cathode active material layer when viewed in the laminating direction of the electrode laminate.

The solid electrolyte layer of the present disclosure contains at least a solid electrolyte. For details of the solid electrolyte contained in the solid electrolyte layer of the present disclosure, the above description regarding the cathode active material layer of the present disclosure can be referenced.

### Anode Active Material Layer

In the present disclosure, the anode active material layer is included in each of the electrode laminates. The anode active material layer of the present disclosure contains at least anode active material particles, and may optionally contain a solid electrolyte, a binder, and a conductive aid. For example, the anode active material layer can be obtained by applying an anode mixture containing at least the anode active material particles to the separator layer or the solid electrolyte layer.

In the present disclosure, the dimension of the anode active material layer may be larger than the dimension of the cathode active material layer when viewed in the laminating direction of the electrode laminate.

The anode active material is not particularly limited, and may be lithium metal, or a material capable of storing and releasing metal ions such as lithium ions. Examples of the material capable of storing and releasing metal ions such as lithium ions include, but are not limited to, alloy-based anode active materials, carbon materials, and lithium titanate (Li₄Ti₅O₁₂).

The alloy-based anode active materials are not particularly limited, and examples thereof include Si-alloy-based anode active materials and Sn-alloy-based anode active materials. Examples of the Si-alloy-based anode active materials include silicon, silicon oxides, silicon carbides, silicon nitrides, and solid solutions thereof. The Si-alloy-based anode active materials may also contain metal elements other than silicon, such as Fe, Co, Sb, Bi, Pb, Ni, Cu, Zn, Ge, In, Sn, and Ti. Examples of the Sn-alloy-based anode active materials include tin, tin oxides, tin nitrides, and solid solutions thereof. The Sn-alloy-based anode active materials may also contain metal elements other than tin.

The carbon materials are not particularly limited, and examples thereof include graphite.

The shape of the anode active material is not particularly limited, and may be, for example, a spherical shape or a fibrous shape.

The particle size D₅₀ of the anode active material may be, for example, 1 nm or more, 5 nm or more, or 10 nm or more, and may be 500 μm or less, 100 μm or less, 50 μm or less, or 30 μm or less. The particle size D₅₀ is defined as the particle size (median diameter) corresponding to 50% of the volume-based cumulative particle size distribution as determined by a laser diffraction and scattering method.

For details of the anode active material layer of the present disclosure, the description regarding the cathode active material layer of the present disclosure can be referenced.

### Anode Metal Foil

In the present disclosure, the anode metal foil of each of the electrode laminates is in contact with the anode vapor-deposited metal film of the anode metal-vapor-deposited resin layer such that a plurality of the anode metal foils is electrically connected in parallel to each other.

For details of the anode metal foil of the present disclosure, the description regarding the cathode metal foil of the present disclosure can be referenced. As the material of the anode metal foil of the present disclosure, a metal having reduction resistance is particularly preferred.

### Cathode Metal-vapor-deposited Resin Layer

In the present disclosure, the cathode metal-vapor-deposited resin layer includes a resin layer and the cathode vapor-deposited metal film.

### Resin Layer

In the present disclosure, the resin layer of the cathode metal-vapor-deposited resin layer is not particularly limited, but a resin having high heat resistance is preferably used. Examples of the resin layer include, but are not limited to, polypropylene (PP) and polyethylene terephthalate (PET) layers.

In the present disclosure, the thickness of the resin layer is not particularly limited, but may be 0.1 μm or more, 0.3 μm or more, 0.5 μm or more, 1.0 μm or more, or 5.0 μm or more, and may be 100 μm or less, 80 μm or less, 30 μm or less, 10 μm or less, or 5.0 μm or less.

### Cathode Vapor-deposited Metal Film

In the present disclosure, the cathode vapor-deposited metal film is vapor-deposited on the resin layer and is in contact with the cathode metal foil of each of the electrode laminates such that the cathode vapor-deposited metal film is electrically connected to the cathode metal foil.

In the present disclosure, the thickness of the cathode vapor-deposited metal film is not particularly limited, but may be 1 nm or more, 3 nm or more, 10 nm or more, 50 nm or more, or 100 nm or more, and may be 1.0 μm or less, 800 nm or less, 500 nm or less, or 150 nm or less.

In the present disclosure, examples of the material of the cathode vapor-deposited metal film include, but are not limited to, aluminum, aluminum alloys, stainless steel, and nickel.

### Anode Metal-vapor-deposited Resin Layer

In the present disclosure, the anode metal-vapor-deposited resin layer includes a resin layer and the anode vapor-deposited metal film.

### Resin Layer

For details of the resin layer of the anode metal-vapor-deposited resin layer of the present disclosure, the above description regarding the cathode metal-vapor-deposited resin layer of the present disclosure can be referenced.

### Anode Vapor-deposited Metal Film

In the present disclosure, the anode vapor-deposited metal film is vapor-deposited on the resin layer and is in contact with the anode metal foil of each of the electrode laminates such that the anode vapor-deposited metal film is electrically connected to the anode metal foil.

For details of the anode vapor-deposited metal film of the present disclosure, the description regarding the cathode vapor-deposited metal film of the present disclosure can be referenced.

### Resin Sealing Member

In the present disclosure, the resin sealing member is provided between the cathode metal foil and the anode metal foil. The cathode active material layer, the separator layer or the solid electrolyte layer, and the anode active material layer of each of the electrode laminates are sealed with the resin sealing member, the cathode metal foil, and the anode metal foil.

In the present disclosure, the resin sealing member is not particularly limited as long as it is a resin that can be fused to metal. The resin sealing member may be, but is not limited to, a thermoplastic film containing polypropylene (PP).

In the present disclosure, the resin sealing member is not particularly limited in terms of shape and/or position as long as it seals the cathode active material layer, the separator layer or the solid electrolyte layer, and the anode active material layer of each of the electrode laminates. That is, for example, the resin sealing member may or may not be in contact with the cathode active material layer, the separator layer or the solid electrolyte layer, and/or the anode active material layer. The peripheral edge of the resin sealing member may or may not be in direct contact with the cathode vapor-deposited metal film and/or the anode vapor-deposited metal film.

In the present disclosure, the dimension of the separator layer or the solid electrolyte layer and/or the dimension of the anode active material layer may be larger than the dimension of the cathode active material layer when viewed in the laminating direction of the electrode laminate. The resin sealing member may be in contact with the peripheral edge of the separator layer or the solid electrolyte layer and/or the peripheral edge of the anode active material layer, and may or may not be in contact with the peripheral edge of the cathode active material layer. That is, in the present disclosure, the dimension of the separator layer or the solid electrolyte layer and/or the dimension of the anode active material layer may be larger than the dimension of the cathode active material layer when viewed in the laminating direction of the electrode laminate, and the resin sealing member may be in contact with the peripheral edge of the separator layer or the solid electrolyte layer and/or the peripheral edge of the anode active material layer.

The present disclosure will be described in more detail below with reference to examples. However, these examples are not intended to limit the scope of the disclosure.

### Example 1

### Fabrication of Electrode Laminate

A cathode mixture containing LiNiCoMn as a cathode active material, LiI-LiBr-Li₂S-P₂S₅ as a solid electrolyte, vapor grown carbon fibers as a conductive aid, and butadiene rubber as a binder was prepared. An anode mixture containing graphite as an anode active material, LiI-LiBr-Li₂S-P₂S₅ as a solid electrolyte, vapor grown carbon fibers as a conductive aid, and butadiene rubber as a binder was prepared.

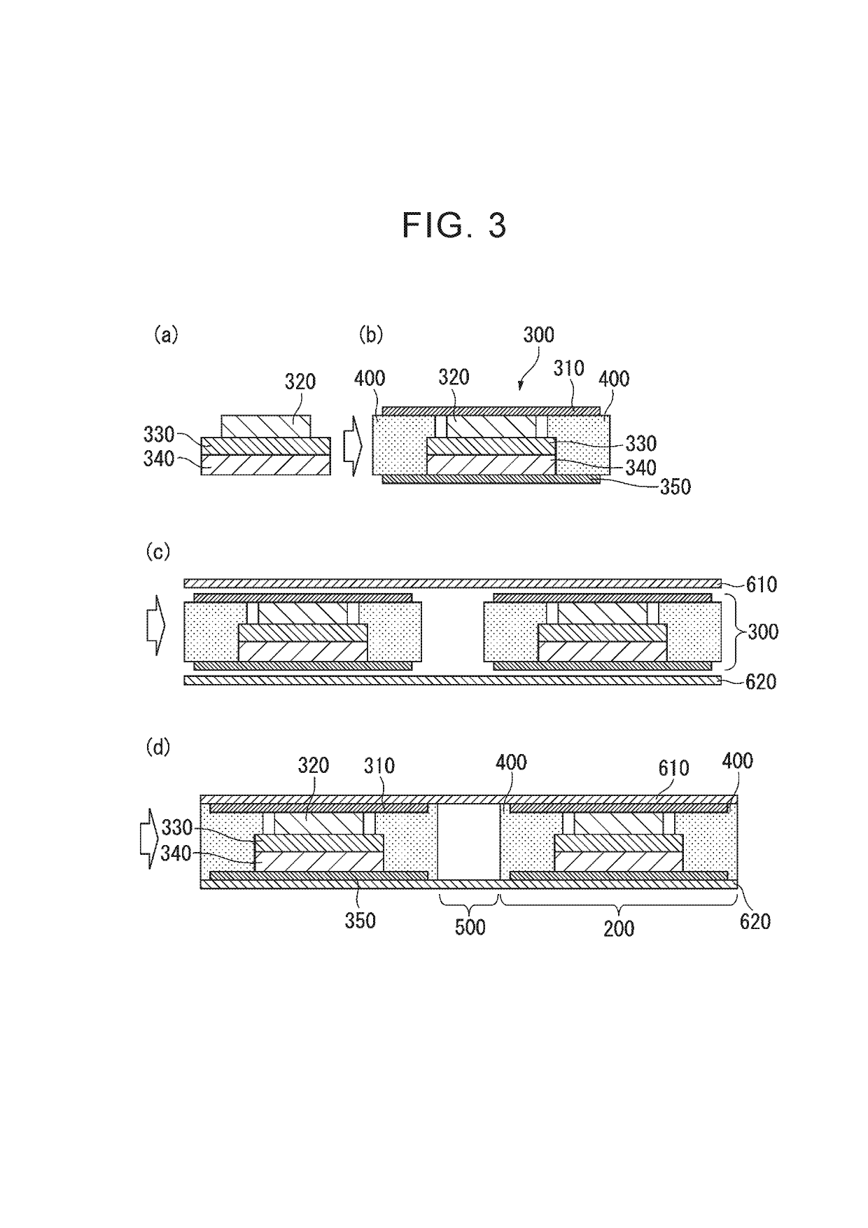

FIG. 3 shows details of the example. The cathode active material layer 320 and the anode active material layer 340 were produced by applying the cathode mixture to one surface of the separator layer 330 that was a mixture of a solid electrolyte and butadiene rubber and applying the anode mixture to the other surface of the separator layer 330, respectively (part (a) in FIG. 3).

Then, the cathode metal foil 310 (aluminum foil) and the anode metal foil 350 (nickel foil) were disposed such that the cathode active material layer 320 came into contact with the cathode metal foil 310 and the anode active material layer 340 came into contact with the anode metal foil 350. Then, a thermoplastic film containing polypropylene was disposed as the resin sealing member 400 between the cathode metal foil 310 and the anode metal foil 350 and on the peripheral edge of the separator layer 330. Then, the resultant was heated under reduced pressure at 150°C for 1 minute to fabricate a plurality of electrode laminates 300 each including the cathode metal foil 310, the cathode active material layer 320, the separator layer 330, the anode active material layer 340, and the anode metal foil 350 laminated in the stated order (part (b) in FIG. 3). In each electrode laminate 300, the cathode active material layer 320, the separator layer 330, and the anode active material layer 340 were sealed with the cathode metal foil 310, the resin sealing member 400, and the anode metal foil 350.

### Fabrication of Electrode Laminate Module

Polyethylene terephthalate films each containing aluminum vapor-deposited on one surface were prepared as the cathode metal-vapor-deposited resin layer 610 and the anode metal-vapor-deposited resin layer 620, and were disposed such that the surface of the cathode metal-vapor-deposited resin layer 610 where aluminum was vapor-deposited came into contact with the cathode metal foil 310 and the surface of the anode metal-vapor-deposited resin layer 620 where aluminum was vapor-deposited came into contact with the anode metal foil 350. Then, the resultant was heated under reduced pressure at 160°C for 1 minute to fabricate an electrode laminate module 100 in which the cathode metal-vapor-deposited resin layer 610 was connected to the cathode metal foil 310 and the anode metal-vapor-deposited resin layer 620 was connected to the anode metal foil 350. The resin sealing member 400 of the electrode laminate module was in contact with the cathode metal-vapor-deposited resin layer 610 and the anode metal-vapor-deposited resin layer 620.

The electrode laminate module fabricated in Example 1 was repeatedly bent at the unsealed portion.

What is claimed is:

1. An electrode laminate module comprising a plurality of electrode laminates, a cathode metal-vapor-deposited resin layer, and an anode metal-vapor-deposited resin layer, wherein
each of the electrode laminates includes at least a cathode metal foil, a cathode active material layer, a separator layer or a solid electrolyte layer, an anode active material layer, and an anode metal foil in the stated order,
the cathode metal foil of each of the electrode laminates is in contact with a cathode vapor-deposited metal film of the cathode metal-vapor-deposited resin layer such that a plurality of the cathode metal foils is electrically connected in parallel to each other,
the anode metal foil of each of the electrode laminates is in contact with an anode vapor-deposited metal film of the anode metal-vapor-deposited resin layer such that a plurality of the anode metal foils is electrically connected in parallel to each other, and
the cathode active material layer, the separator layer or the solid electrolyte layer, and the anode active material layer of each of the electrode laminates are sealed with the cathode metal foil, the anode metal foil, and a resin sealing member between the cathode metal foil and the anode metal foil.

2. The electrode laminate module according to claim 1, wherein:
a dimension of the separator layer or the solid electrolyte layer and a dimension of the anode active material layer are larger than a dimension of the cathode active material layer when viewed in a laminating direction of the electrode laminate; and
the resin sealing member is in contact with a peripheral edge of the separator layer or the solid electrolyte layer and/or a peripheral edge of the anode active material layer, and is not in contact with a peripheral edge of the cathode active material layer.

3. The electrode laminate module according to claim 1, wherein a thickness of the cathode vapor-deposited metal film and/or the anode vapor-deposited metal film is 1.0 μm or less.

4. The electrode laminate module according to claim 1, wherein a thickness of the cathode metal foil and/or the anode metal foil is 5 μm or more and 500 μm or less.

5. The electrode laminate module according to claim 1, wherein:
a sealed portion that is sealed with the resin sealing member and an unsealed portion other than the sealed portion are provided when viewed in a laminating direction of the cathode metal-vapor-deposited resin layer and the anode metal-vapor-deposited resin layer; and
the cathode vapor-deposited metal film and the anode vapor-deposited metal film do not overlap each other at the unsealed portion when viewed in the laminating direction of the cathode metal-vapor-deposited resin layer and the anode metal-vapor-deposited resin layer.
